(19) United States
(12) Patent Application Publication
(10) Pub. No.: US 2010/0006382 A1
(43) Pub. Date: Jan. 14, 2010

(54) BRACKET FOR MOUNTING SHOCK ABSORBER

(75) Inventor: Sung Hoon Ahn, Gyeonggi-do (KR)

Correspondence Address: SEED INTELLECTUAL PROPERTY LAW GROUP PLLC, 701 FIFTH AVE, SUITE 5400, SEATTLE, WA, 98104, US

(73) Assignee: MANDO CORPORATION, Gyeonggi-do (KR)

(21) Appl. No.: 12/501,265

(22) Filed: Jul. 10, 2009

(30) Foreign Application Priority Data
Jul. 11, 2008 (KR) 10-2008-0067475

(51) Int. Cl. F16F 9/54

(52) U.S. Cl. 188/321.11

(57) ABSTRACT

A bracket for mounting a shock absorber configured to couple a distal end of a piston rod of the shock absorber to a vehicle body includes a body having a recess formed therein, the recess configured to receive a bush assembly, a flange extending from the body, and at least one lateral reinforcement rib formed between the flange and the body to reinforce the bracket.

### BACKGROUND

1. Technical Field

The present disclosure relates to a mounting structure of a shock absorber for vehicles, and more particularly, to a bracket for mounting a piston rod of a shock absorber to a vehicle body.

2. Description of the Related Art

In general, a vehicle is provided with a suspension system between a vehicle body and an axle to prevent damage to the vehicle and to enhance ride comfort by relieving or absorbing impact or vibration transmitted from a road surface to the axle during traveling on the road.

To this end, suspension systems typically include a suspension spring relieving impact from the road surface, a shock absorber suppressing free vibration of the suspension spring to enhance ride comfort, and the like. The suspension spring and the shock absorber cooperate with each other to provide further enhanced ride comfort to persons in the vehicle.

More specifically, the suspension spring generally absorbs impact caused by vibration of the vehicle body due to unevenness of a road surface and the shock absorber supplies resistance to the suspension spring to stop vibration of the suspension spring.

The shock absorber typically includes a cylinder and a piston rod, one side of which is inserted into the cylinder. The piston rod is provided with a piston valve or the like within the cylinder.

The cylinder is provided at an upper side thereof with a dust cover surrounding the piston rod and an upper portion of the cylinder to prevent foreign matter from being introduced into the cylinder. The dust cover is usually provided at an inner side thereof with a bumper stopper, which is fitted into the piston rod to absorb impact loads transmitted from wheels to the vehicle body when the shock absorber is completely compressed.

Generally, the shock absorber is disposed between the vehicle body and the wheel, with an upper end of the piston rod secured to the vehicle body and a lower end of the cylinder secured to a wheel side. To this end, the upper end of the piston rod is provided with an upper mounting structure secured to the vehicle body, and the lower end of the cylinder is provided with a knuckle bracket connected to the axle.

The upper mounting structure of a conventional shock absorber includes a bracket 110, shown in FIG. 1, formed of steel or aluminum by pressing or aluminum injection molding and a bush assembly 120 press-fitted into the bracket 110 with the upper end of the piston rod coupled thereto.

The bracket 110 has a body 112, which is formed at a center thereof with a cylindrical recess for receiving the bush assembly 120 press-fitted into the bracket 110 as mentioned above, and flanges 113 extending from opposite sides of the body 112 of the bracket 110 and formed with bolt bores 113a, into which bolts are inserted for coupling with the vehicle body, respectively.

The cylindrical recess is formed at a center thereof with a through-hole through which the piston rod can pass, and the body 112 of the bracket 110 is formed at a lower portion thereof with a mounting portion on which the dust cover and the bumper stopper are mounted.

The bush assembly 120 includes a rubber 121 for preventing vibration of the wheel transmitted through the piston rod from being transmitted to the vehicle body, a plate member embedded in the rubber 121, a washer and a nut for coupling the upper end of the piston rod to the plate member, and a pipe member attached to an outer periphery of the rubber 121.

The pipe member has a cylindrical shape and is sized such that the bush assembly can be press-fitted into the recess of the bracket 110, thereby preventing the bush assembly 110 from being separated from the bracket 110.

On the other hand, in the upper mounting structure of the conventional shock absorber described above, the bracket 110 is formed by steel pressing or aluminum injection molding. The steel pressing of the bracket 10 causes many restrictions in shape and size of the bracket 110 and results in an excessively heavy weight of the bracket 10, which adds to the vehicle weight when installed. The aluminum injection molding of the bracket also requires considerable material and machining costs, and therefore excess metallic waste.

### BRIEF SUMMARY

According to one embodiment, a bracket for mounting a shock absorber is formed of plastics to reduce material and machining costs while enabling easy manufacture and handling of the bracket, and includes reinforcement structure configured to facilitate formation of the mounting bracket from a non-metallic material, such as plastic. The reinforcement structure can include ribs on lateral and inner surfaces of a bracket body for reinforcement of the bracket.

According to an aspect, there is provided a bracket for mounting a shock absorber. The bracket can be used for an upper mounting structure of the shock absorber to couple a distal end of a piston rod of the shock absorber to a vehicle body, and includes a body having a recess formed therein, the recess allowing a bush assembly inserted therein; a flange extending from the body; and at least one lateral reinforcement rib formed between the flange and the body to reinforce the bracket.

According to one embodiment, the bracket may further include an inner reinforcement rib formed around or adjacent a through-hole in an inner bottom surface of the recess.

According to one embodiment, the bracket may further include a radial reinforcement rib formed on the inner bottom surface of the recess to radially extend from the inner reinforcement rib.

According to one embodiment, the bracket may further include a seat portion allowing a reinforcement washer to be inserted therein to reinforce the flange, the seat portion being formed around or adjacent a bolt fastening bore in the flange

According to one embodiment, the bracket is formed of a plastic material and further includes a mounting portion formed at a lower side of the body such that a dust cover and a bumper rubber are mounted on the mounting portion.

### BRIEF DESCRIPTION OF THE SEVERAL VIEWS OF THE DRAWINGS

FIG. 1 is an isometric view of a bracket for mounting a shock absorber according to prior art;

FIG. 2 is a cross-sectional top isometric view of a bracket for mounting a shock absorber according to one embodiment;

FIG. 3 is a bottom isometric view of a bracket according to one embodiment; and

FIG. 4 is a cross-sectional top isometric view of a bracket for mounting a shock absorber according to one embodiment.

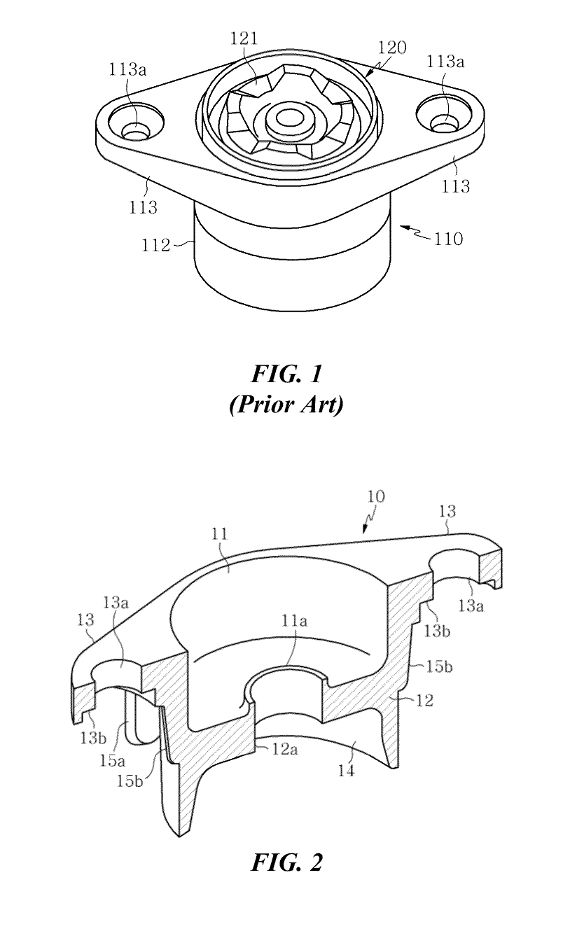

### DETAILED DESCRIPTION

Hereinafter, example embodiments of the invention will be described with reference to accompanying drawings in FIGS. 2-4.

Generally, a shock absorber is disposed between a vehicle body and a wheel, with an upper end of a piston rod secured to the vehicle body and a lower end of a cylinder secured to a wheel side. The upper end of the piston rod is typically provided with an upper mounting structure configured to be secured to the vehicle body, and the lower end of the cylinder is typically provided with a mounting structure, such as a knuckle bracket, configured to be connected to the axle.

The upper mounting structure of the shock absorber can include a bracket, a bush assembly, or the like. The piston rod of the shock absorber can be connected to the vehicle body via the bracket.

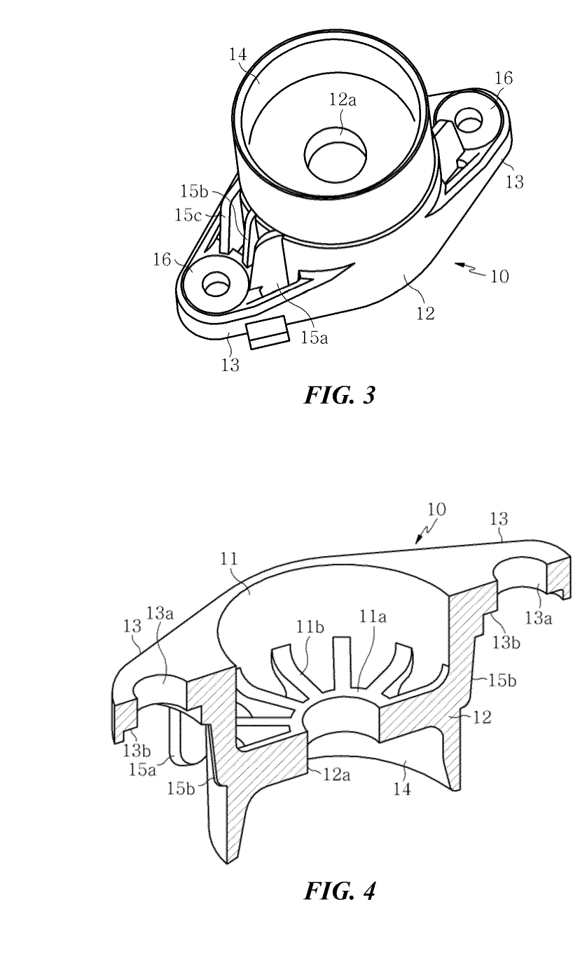

FIGS. 2 and 3 illustrate a bracket for mounting a shock absorber according to one embodiment. FIG. 2 is a cross-sectional top isometric view of the bracket according to one embodiment, and FIG. 3 is a bottom perspective view of the bracket according to one embodiment.

The bracket 10 for mounting a shock absorber can be formed of a plastic material by injection molding. Referring to FIGS. 2 and 3, the bracket 10 includes a substantially cylindrical body 12 having a recess 11 into which a bush assembly can be inserted, flanges 13 extending from opposite sides of the body 12, and a mounting portion 14 formed at a lower side of the body 12 such that a dust cover (not shown) and a bumper stopper (not shown) can be mounted thereon.

A detailed configuration of the bush assembly does not limit the scope of the present invention, and a detailed description thereof will be omitted herein.

In one aspect, each of the flanges 13 extending from the opposite sides of the body 12 can be formed with a bolt fastening bore 13a into which a bolt (not shown) can be inserted for coupling to a vehicle body. In one aspect, the recess 11 formed at the upper portion of the body 12 of the bracket 10 is formed at a center thereof with a through-hole 12a through which a piston rod (not shown) can pass.

According to one embodiment, one or more lateral reinforcement ribs, for example, first, second, and third lateral reinforcement ribs 15a, 15b, 15c, are formed between each of the flanges 13 and the body 10 to reinforce the bracket 10. Referring to FIG. 3, the first and third reinforcement ribs 15a, 15c are shown as having a greater size than the second lateral reinforcement rib 15b disposed therebetween. However, it should be understood that the size of the lateral reinforcement ribs may be changed as needed according to a design criteria of the bracket 10.

Referring again to FIG. 2, in one aspect, the bracket 10 has a circular inner reinforcement rib 11a formed around or adjacent the through-hole 12a on an inner bottom surface of the recess 11.

Further, in one aspect, each of the flanges 13 has a seat portion 13b formed around the bolt fastening bore 13a on the lower surface of the flange 13 such that the reinforcement washer 16 (FIG. 3) can be fitted into the seat portion 13b. Therefore, the reinforcement washer 16 is fitted into the seat portion 13b around each of the bolt fastening bores 13a, thereby reinforcing the flanges 13 when the flanges 13 are coupled by bolts.

FIG. 4 is a cross-sectional top isometric view of a bracket for mounting a shock absorber taken in the longitudinal direction according to another embodiment.

The bracket 10 for mounting a shock absorber according to this embodiment can be formed of a plastic material by injection molding. The bracket 10 of this embodiment includes a substantially cylindrical body 12 having a recess 11 into which a bush assembly can be inserted, flanges 13 extending from opposite sides of the body 12, and a mounting portion 14 formed at a lower side of the body 12 such that a dust cover (not shown) and a bumper stopper (not shown) can be mounted thereon.

The bracket 10 according to this embodiment includes a circular inner reinforcement rib 11a formed around a through-hole 12a on an inner bottom surface of the recess 11 and a radial reinforcement rib 11b radially extending from the inner reinforcement rib 11a. The other configurations of the bracket 10 according to the second embodiment can be similar to those described above with respect to the illustrated embodiment of FIG. 2, and a detailed description thereof will be omitted herein.

As apparent from the above description, according to the embodiments of the invention, the bracket for mounting a shock absorber is formed of a plastic material and includes reinforcement ribs provided in lateral and inner surfaces of a bracket body for reinforcement of the bracket.

Accordingly, the bracket according to the embodiments enables a reduction in material and machining costs while facilitating manufacture and handling of the bracket.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A bracket configured to couple a piston rod of a shock absorber to a vehicle body, the bracket comprising:
a body having a recess formed therein, the recess configured to receive a bush assembly;
a flange extending from the body; and
at least one lateral reinforcement rib formed between the flange and the body to reinforce the bracket.

2. The bracket of claim 1, further comprising:
an inner reinforcement rib formed around a through-hole in an inner bottom surface of the recess.

3. The bracket of claim 2, further comprising:
a radial reinforcement rib formed on the inner bottom surface of the recess to radially extend from the inner reinforcement rib.

4. The bracket of claim 1, further comprising:
a seat portion allowing a reinforcement washer to be inserted therein to reinforce the flange, the seat portion being formed around a bolt fastening bore in the flange

5. The bracket of claim 1 wherein the bracket is formed of a non-metallic material.

6. The bracket of claim 5 wherein the bracket is fabricated from a plastic material.

7. The bracked of claim 1, further comprising:
a mounting portion formed at a lower side of the body configured to be coupled to a dust cover and a bumper rubber.
